(19) United States
(12) Patent Application Publication
(10) Pub. No.: US 2013/0120970 A1
(43) Pub. Date: May 16, 2013

(54) HAND-HELD DEVICE WITH A MULTI-MODE LIGHT SOURCE AND A SECONDARY ILLUMINATION SOURCE

(71) Applicants: NORBERTO ROJO, PHOENIX, AZ (US); AVERY HARRIS, SCOTTSDALE, AZ (US); JAY HARRIS, ALISO VIEJO, CA (US)

(72) Inventors: NORBERTO ROJO, PHOENIX, AZ (US); AVERY HARRIS, SCOTTSDALE, AZ (US); JAY HARRIS, ALISO VIEJO, CA (US)

(21) Appl. No.: 13/673,957

(22) Filed: Nov. 9, 2012

Related U.S. Application Data
(60) Provisional application No. 61/558,602, filed on Nov. 11, 2011.

(51) Int. Cl. F21V 33/00

(52) U.S. Cl. 362/99

(57) ABSTRACT

A hand-held device for managing documents or cards and associated light sources both for illuminating the documents in use, and an adjacent object or person. The hand-held device described herein provides the capability to individuals working in unlit or dimly lit areas the ability to view a document or record information while being able to illuminate another subject, without the use of a separate flashlight.

### RELATED APPLICATIONS

This Utility Patent Application claims the benefit of priority to U.S. Provisional Patent Application No. 61/558,602 entitled “Hand-Held Device With a Multi-Mode Light Source and a Secondary Illumination Source” filed Nov. 11, 2011.

### FIELD OF THE INVENTION

The present invention relates to a hand-held device with a surface for holding and/or securing in place any kind of paper, document(s), card or cards (i.e., identification cards), or any other flat material(s), while at the same time having a first illumination means for the surface of the hand-held device, and a second illumination means for illuminating an area adjacent to the hand-held device.

### BACKGROUND OF THE INVENTION

Historically, a law enforcement officer, security professional, emergency medical technician, cable repairman, or firefighter or other similar worker in the field (hereinafter, “user”) during the day or night may be required to record information by way of writing on a flat surface such as a clipboard. At times this process may require the user to interact with another individual, involving the use of multiple items during the interaction. During such an interaction, the user may need to multi-task, juggling various items such as a pen, flashlight, identification card (“ID”), or other documents such as vehicle registration, proof of insurance, field interview (“FI”) card, etc. This presents an awkward situation for the user who must then simultaneously hold the documents, write, and focus on other individuals. Further, the user may not have an adequately flat surface available for recording necessary information during this interaction. This situation might require the user to use the surface of a car, the sidewalk, or the back of another individual in the absence of a clipboard or another adequate surface. Juggling multiple items while attempting to write may further distract the user, potentially leaving them vulnerable to attack, as in the case of law enforcement.

Moreover at night, even if the users are equipped with a clipboard, without the use of a car headlight, flashlight in their teeth, or some other independent light source, users are unable to simultaneously hold a clipboard, record required information, and a flashlight to illuminate the material and the face of another individual.

Thus, based on the foregoing, there is a need for a device that allows a user to simultaneously manage and illuminate documents or paperwork while incorporating an additional layer of safety and security to the user by providing a high-powered light source the user can aim in a desired direction.

### SUMMARY OF THE INVENTION

The present invention combines the utility and convenience of a clipboard for the management of documents and ease of writing in the absence of another writing surface such as a table or desk, with multiple illumination devices, and manner of securing the device to the user's hand.

The present invention includes a base providing a flat surface suitable for writing with a fastener for securing a document or card to the base. The fastener may be a single clip similar to that in a common clipboard, or a plurality of clips or other fasteners provided to enable the user to secure the top, bottom, or sides of a given document or card. Further, the base may be sized to accommodate multiple types of documents or multiple documents at once. A preferred embodiment may be sized particularly for a standard sheet of paper, while another preferred embodiment might be smaller for mobility and storage, sized for a specific use such as a traffic citation or ID card. Other preferred embodiments include a strap for securing the base to the hand of the user.

Further provided in the present invention are multiple light sources. The multiple light sources enable the user to view or write on documents secured to the base, while providing an additional light source for the simultaneous illumination of an adjacent subject.

A preferred embodiment of the present invention considers a situation such as a law enforcement officer taking a field interview (“FI”) or making a traffic stop at night. Ordinarily such an officer will have his issued flashlight in use when he approaches the witness or suspect vehicle and driver. If issuing a traffic citation, the officer will likely utilize a clipboard to fill out the citation illuminating it with the lights from his police cruiser as he will have to secure his flashlight or hold it in the same hand as the clipboard as he writes with his opposite hand. This prevents the officer from both writing and maintaining the light source on the suspect or driver all at once.

The present invention solves the officers problem in this matter by providing a first light source to illuminate the documents secured to the clipboard, while a second light source is provided to illuminate the suspect vehicle or the driver's face, as required. In the case of a field interview, the officer may clip the witness' ID card to the provided clip on the handheld device while having sufficient area on the flat surface of the base to fill out the index card or FI card. The provided lights are then capable of illuminating both the FI card and the witness' face simultaneously.

The utility of the present invention is not limited to a traffic stop or field interview as it provides a similar solution to a cable repairman working in a dark location, a city utilities inspector, or any other user that needs to see what they are writing while providing light in another direction.

Various embodiments of the present invention incorporate a writing surface, a fastener for maintaining the position of a document, with one light focused on the document, another light source focused in a user-adjustable direction, a storage compartment, and removable or adjustable hand strap.

### DESCRIPTION OF THE DRAWING

The objects, features, and advantages of the method according to the invention will be more clearly perceived from the following detailed description, when read in conjunction with the accompanying drawing, in which:

FIG. 1 depicts an exemplary user conducting a traffic stop, approaching the driver of the suspect vehicle, with the present invention in use, a first document attached to the base by a first fastener and illuminated by a first light source, while a second fastener is provided to display a second document, such as proof of insurance or the driver's identification card, as a second light source illuminates the car and driver;

FIG. 2 depicts a plan view of a preferred embodiment of the present invention, showing the first fastener at the top of the present invention securing a document, which is illuminated by the first light source formed to the first fastener, and the second light source shining out of the top of the present invention;

FIG. 3 depicts an isometric view of the preferred embodiment of FIG. 2, showing a first fastener for securing documents on the top of the base of the invention, and associated first light source for illuminating the document, in addition to the second light source, shining away from the base in a user-adjustable direction for illuminating a subject adjacent to the device;

FIG. 4 depicts an isometric view of an alternative embodiment of the present invention, showing the base section of the handheld device unlatched from the lower section and open at the hinge along the top of the hand-held device, further showing a document secured by the first fastener and illuminated by the associated first light source, a second fastener at the bottom of the base of the hand-held device securing an ID card or similar, and various writing implements stored in the interior of the base of the hand-held device, further showing the second light source shining in a user-adjustable direction for illuminating a subject adjacent to the device;

FIG. 5 is an isometric view of an alternative embodiment of the present invention showing a document secured to the base of the hand-held device with the first fastener and illuminated by the associated first light source formed into the first fastener, a sliding tray extended from the base of the hand-held device revealing a storage area for various writing implements, further showing the second light source shining in a user-adjustable direction for illuminating a subject adjacent to the device;

FIG. 6 is a perspective view of the rear of the base of an embodiment of the present invention showing access to the power supply, showing the access panel and power switches for the plurality of integral light sources;

FIG. 7 is an exemplary circuit diagram for an embodiment of the present invention, showing a power supply, a ground, and integrated circuits for powering the integral light sources and their individual controllers, each with its own power switch;

FIG. 8 is an isometric view of an alternative preferred embodiment, showing a field investigation card secured in a two-sided fastener, two directable lights for illumination of the documents in the lower portion, power switches for the associated light, and light emanating from the second light source;

FIG. 9 is an isometric view of an alternative preferred embodiment of the FIG. 8, showing a field investigation card and a drivers' license each secured in one side of the two-sided fastener, two directable light sources on the base of the invention for illumination of the two documents, power switches for the associated lights, and light emanating from the second light source;

FIG. 10 is a plan view of the base of the alternative preferred embodiment of FIG. 8 showing a two-sided fastener at the top of the invention, two directable light sources on the base of the invention for illumination of documents, a second light source on the top of the invention shining in a user-adjustable direction for illuminating a subject adjacent to the device, and exemplary dimensions of the embodiment;

FIG. 11 is a top view of the alternative preferred embodiment of FIG. 8, showing the top of the invention, two directable light sources, two-sided fastener, the second light source, and adjustable hand strap;

FIG. 12 is a side view of the alternative preferred embodiment of FIG. 8, showing the side of the invention, one of the two directable light sources, two-sided fastener, second light source, power switch, and hand strap; and

FIG. 13 is an isometric view of the reverse side of alternative preferred embodiment of FIG. 8, showing an adjustable hand strap, its interaction with the reverse side of the hand-held device, the second light source, and the user's hand as it would fit through the adjustable hand strap,

### DETAILED DESCRIPTION

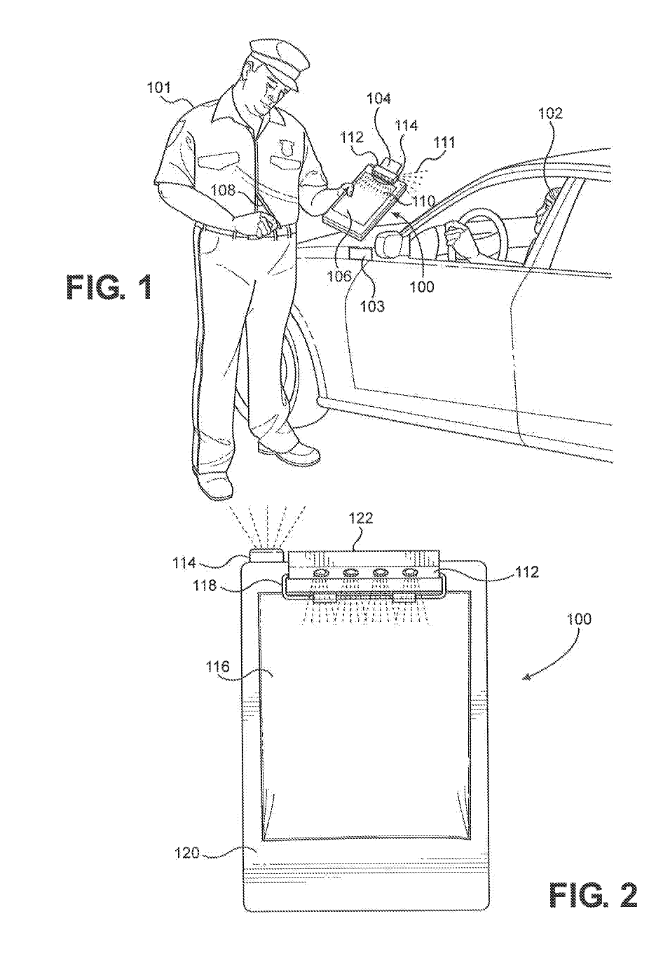

Referring initially to FIG. 1, a law enforcement officer (“user”) 101 is conducting a routine traffic stop and is checking the vehicle driver's 102 documentation: The user 101 is utilizing a preferred embodiment of the present invention, the Hand-Held Device With a Multi-Mode Light Source and a Secondary Illumination Source (“hand-held device”), generally labeled 100 to verify the driver's 102 ID 104, while writing a citation 106. The user 101 has the hand-held device 100 grasped in his left hand, enabling the user 101 to use a pen 108 while simultaneously remaining able to see the citation 106 under the light 110 provided by a first light source 112 from the hand-held device 100. Likewise, user 101 is able to utilize the light 111 from the second light source 114 of hand-held device 100 to illuminate the driver's 102 face and the interior of the vehicle 103.

With the help of hand-held device 100, user 101 is now able to maintain visual contact with the car and driver, while still being able to view and write upon the documents secured to hand-held device 100. Further, user 101 is provided with an additional layer of safety because he is not distracted by other tasks such as holding a flashlight.

Referring now to FIG. 2, hand-held device 100 is shown with a document 116 secured to the base 120 of hand-held device 100 by fastener 118. In this preferred embodiment, a primary light source, alternatively described as a first light source 112, is formed into the first fastener 118, where first light source 112 illuminates document 116. In a preferred embodiment, first light source 112 is constructed from light emitting diodes (“LED”), and may be a single LED or an array of a plurality of LEDs, proving increased illumination. First light source 112 as depicted in this Figure, is constructed of an exemplary array of four LEDs, providing complete illumination of document 116, allowing the user 101 to see the entire page. In an embodiment, the first light source 112 is a detachable multi-LED light bar, allowing the user 101 to detach the first light source 112 in order to replace the unit or to change the type of LEDs utilized. For instance, in such an embodiment the user 101 can replace broken LEDs or change from a white LED to blue LEDs or even to ultra violet LEDs depending on requirements.

It should be appreciated by those skilled in the art that while LEDs are contemplated a primary source of light for hand-held device 100, other light sources may be implemented in order to conserve power while providing a lightweight lighting system that provides sufficient usable light at a low cost and efficient manner.

Similarly, the second light source 114 is also contemplated as a single LED or array of LEDs arranged to provide the user 101 with an additional means of illuminating user's 101 desired subject. Second light source 114 may be a fixed lens, similar to a common flashlight that is directed with the movement of hand-held device 100.

In an embodiment, both the primary, or first light source 112 and second light source 114 employ various lighting modes, allowing the user 101 to select from various intensity levels high, medium, low, off) or modes (steady, strobe).

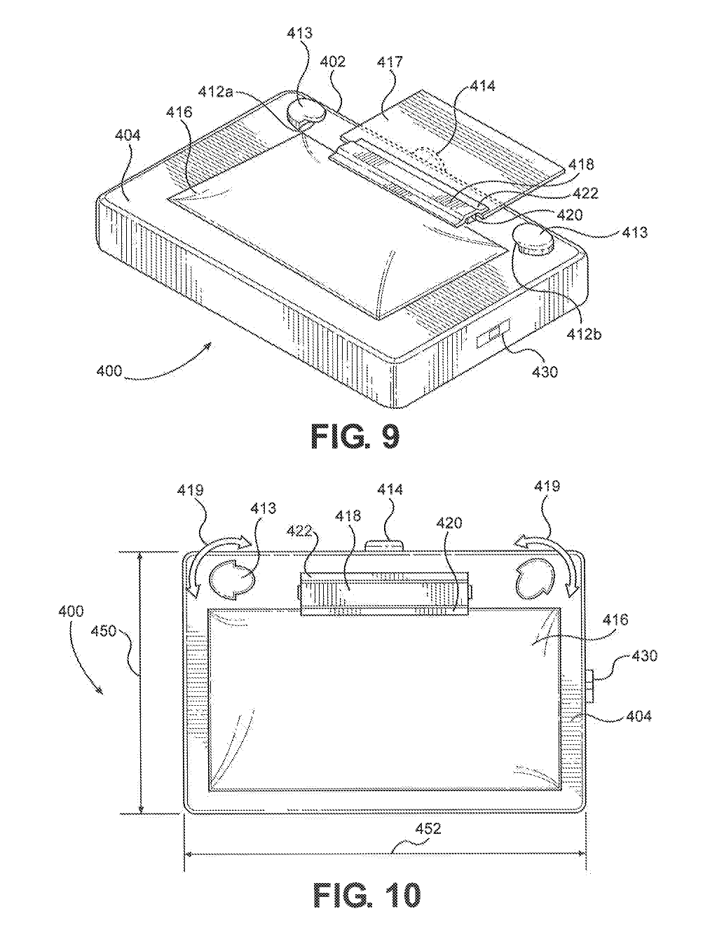

Fastener 118 in the preferred embodiment is contemplated as a hinged and spring-loaded clip, as utilized in a clipboard. Alternatively, however, a sliding mechanism, binder clip, magnetic clasp, hinge and latch system, or other fastener known in the art used to secure documents may further be employed without departing from the spirit of the invention. The orientation of the secured document 116 may be oriented toward user 101 as in this Figure, or it may be oriented in the opposite direction, holding the bottom of a card, ID, or similar, as shown in FIG. 1 with respect to ID 104, and in FIG. 9.

Exemplary document 116 pictured in this Figure is a standard 8.5″×11″ sheet of paper, however in alternative embodiments, the shape of base 120 is modified to suit other applications such as smaller documents, or for easy storage and mobility. In an embodiment, the construction of the present invention is alternatively intended to provide a waterproof or even bulletproof construction.

FIG. 2 further shows the first light source 112 illuminating document 116, allowing user 101 to see it in low-light or no-light conditions. Light source 114 is also shown shining away from the top 122 of base 120 shining in a user 101 selected direction.

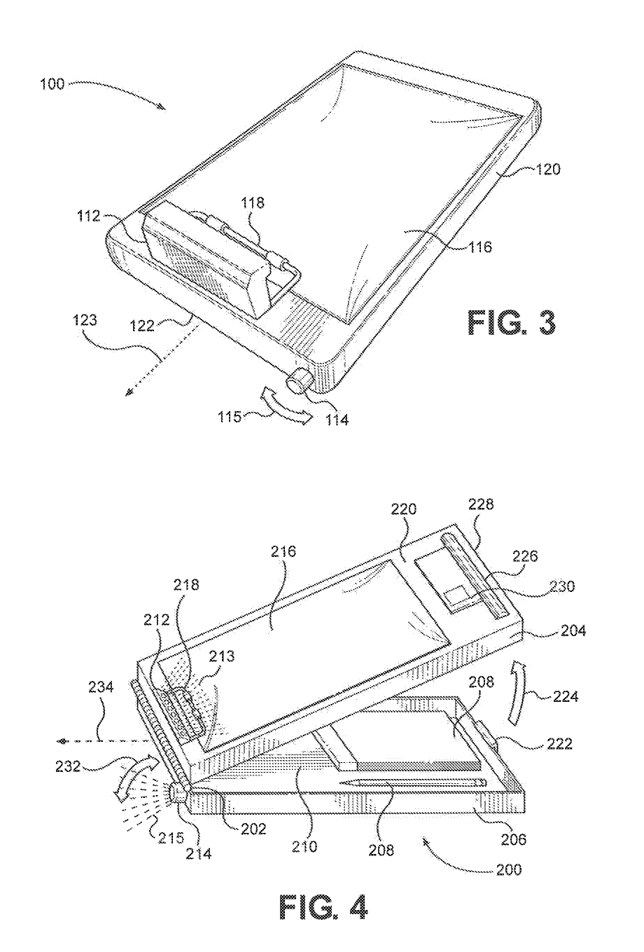

FIG. 3 is an isometric view of the top of the preferred embodiment of FIG. 2, showing document 116 secured to base 120 of hand-held device 100. First light source 112 illuminates document 116 while second light source 114 is formed within base 120, and shines away from user 101 out the top 122 of base 120.

In an alternative embodiment, instead of fixing the axis of second light source 114 in line with the longitudinal axis 123 of the hand-held device 100, second light source 114 may be mounted in an adjustable manner. Second light source can be mounted within a ball-and-socket fixture, or extendable flexible mount (not shown). Such a feature allows user 101 to freely adjust the light off-axis in range 115, either in up and down or eft and right directions.

Referring now to FIG. 4, an alternative embodiment of the present invention is generally labeled 200. The primary difference between hand-held device 100 and hand-held device 200 is the implementation of a hinge 202 connecting upper section 204 to base section 206. This arrangement of hand-held device 200 provides a storage area 210 for various writing implements 208.

This embodiment retains the primary elements of hand-held device 100 with first light source 212, second light source 214, and fastener 218. Thus hand-held device 200 provides the same key functionality as hand-held device 100, providing illumination of document 216, as it is secured to base 220 of upper section 204, with the light 213 from the first light source, and light 215 from the second light source 214.

Latch 222 secures upper section 204 to base section 206, in use. In order to access storage area 210, the latch 222 is actuated, allowing a user to rotate upper section 204 in direction 224, Latch 222 may be a ball-and-groove system, a lever-style latch as shown, or any other system known in the art.

In this alternative embodiment, a second fastener 226 is supplied at the bottom 228 of upper section 204, supplying user 101 with an additional space for another item, such as ID card 230. Depending on the size of the overall construction, in particular, the dimensions of base 220 of hand-held device 200, second fastener 226 may be used to secure the bottom of document 216, further securing document 216 in place when user 101 accesses storage area 210. The fastener 226 may be configured to secure such object(s) against a portion of the writing area that is oriented towards, or closer, to a user 101 of the device 200.

In an embodiment, second light source 214, as shown in this Figure, is further adjustable in range 232, allowing user 101 to direct light 215 off hand-held device's 200 longitudinal axis 234. This is accomplished by mounting second light source 214 within a ball-and-socket system, or similar system known in the art, allowing adjustment of the light 215 in the direction user 101 requires.

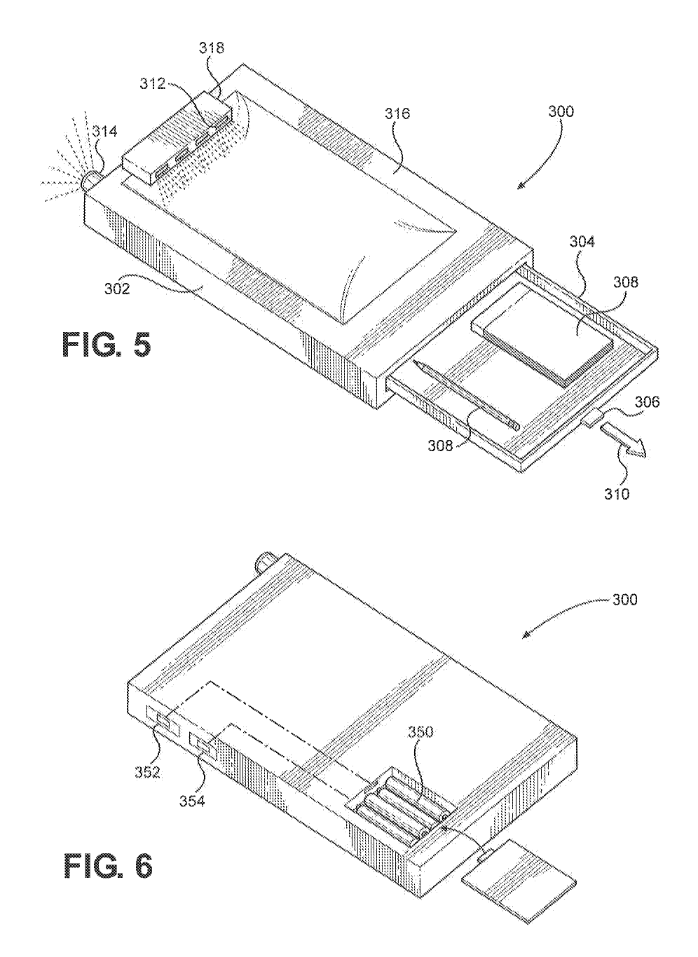

Referring now to FIG. 5, another alternative embodiment of the present invention is generally labeled 300, depicting base 302 and drawer 304. Hand-held device 300 features first light source 312, illuminating document 316, secured in place by fastener 318, while second light source 314 is illuminating an adjacent object or person. Drawer 304 and stored items 308 are accessed by puffing tab 306 in direction 310.

In an embodiment, a calculator (not shown) may be formed into the base 302 of the hand-held device 300. Such an embedded feature may draw its power from the same power source as the light sources 312 and 314 or it may have its own independent source such as a solar panel for use in the daylight.

Referring to FIG. 6, the reverse side of the present invention is depicted, showing access to the power supply, here shown as batteries 350 and the power switches 352 and 354 for activation of the individual light sources. It is to be appreciated by those skilled in the art that many different varieties of power supplies, such as USB and solar power are contemplated and the use of batteries here is not to be considered limiting. The batteries 350 may be rechargeable or disposable while taking advantage of their abundance in the market and ease of replacement. Likewise, the switches 352 and 354 may be any of those commonly known in the art, such that they provide the user 101 a means of applying power to the circuits (shown in FIG. 7) and activating the light sources. Switches 352 and 354 may also be rotary or dial-type mode selectors for choosing the desired light mode. The characteristics of the embodiment described by this Figure may be applied to any of the included embodiments.

FIG. 7 is an exemplary circuit diagram as applied to the present invention. Pictured, are the circuit symbologies of the batteries 350, switches 352 and 354, a first circuit 356, and a second circuit 358. When the switches 352 and 354 are individually actuated, the circuits 356 and 358 supply power to LEDs 360 and 362, and to controllers 366 and 368 independently. LEDs 360 and 362 correspond to the first light sources 112, 212, and 312, and second light sources 114, 214, and 314 from the above-described Figures. Further the controllers 366 and 368 provide flexibility for user-adjustable power settings (high, medium, low, off) and programs (steady, strobe) as discussed above. These different settings may be employed through the use multi-pole or multi-function rotary or dial-type mode selector switches 352 and 354.

It is to be appreciated by those skilled in the art that additional circuits and corresponding multiple light sources may be added without departing from the spirit of the invention. Such additions may be required for the addition of detachable light sources or light bars, as described above, or different light settings, such as high, medium, and low power.

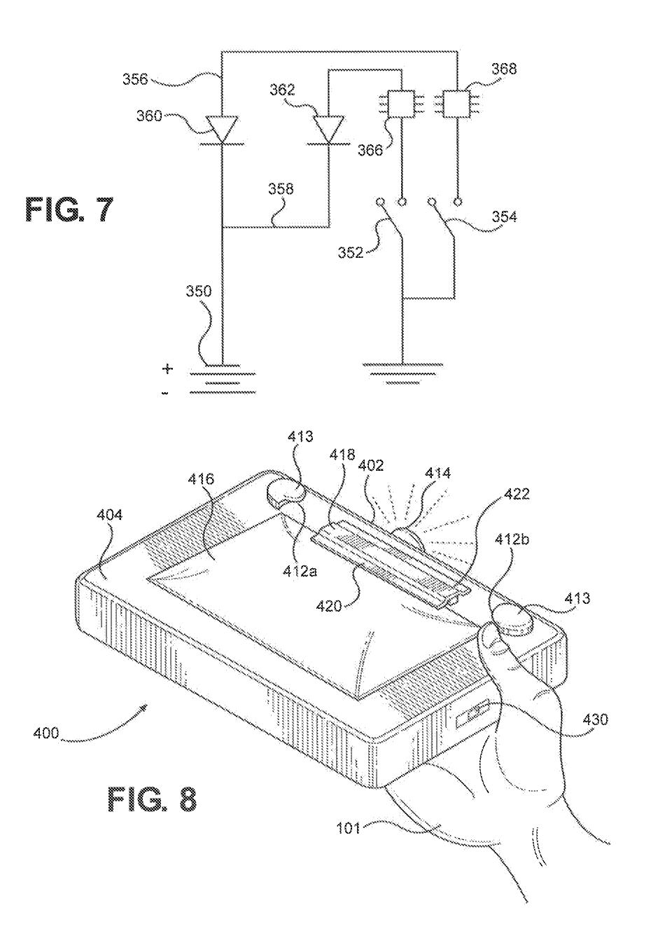

Referring now to FIG. 8 an alternative preferred embodiment of the hand-held device is generally labeled 400. Hand-held device 400 is equipped similar to the above embodiments, albeit in a smaller package. Where previous embodiments were sized to accommodate a standard letter-sized piece of paper, hand-held device 400 is smaller, designed for documents like car registration, IDs, and FI cards. Further, the smaller size enables the user 101 to easily store it in the saddle bag of a police motorcycle or other small storage compartment.

Hand-held device 400 is equipped with first light sources 412a and 412b. Light sources 412a and 412b are each placed on opposite sides of the top 402 of the base 404 of hand-held device 400. Further, light sources 412a and 412b are shrouded, such that they illuminate the document 416 secured to the base 404 by lower clip 420 in two-sided fastener 418. Two-sided fastener 418 provides the ability to secure two documents, one by the top of the document, as in lower clip 420, and another, such as an ID, in the upper clip 422, as shown in FIG. 9.

Shrouds 413 cover light sources 412a and 412b such that they direct light toward document 416. The tops of shrouds 413 are formed so as to direct light coming out of the base 404 of the hand-held device 400 toward the document 416, and not into the eyes of the user 101. This aspect is especially important in dimly lit environments because it prevents the impairment of the user's 101 night vision.

In an embodiment, the user 101 can rotate the shrouds 413 adjusting how much light is provided to document 416, or further remove the shrouds 413 altogether. The left-and-right aspect of light sources 412a and 412b also provide left and right-handed users 101 options for maximizing the illumination of the particular document in use, as user's 101 writing hand block the light coming from that side. That is, a right-handed user 101 would make best use of light source 412a as light source 412b is blocked by his hand when writing.

In an embodiment, the LEDs beneath shrouds 413 and within first light sources 412a and 412b are user-replaceable. Shrouds 413 may be removed, exposing the LEDs within light sources 412a and 412b. This allows for replacement of one or both of the LEDs within light source 412a and 412b, In an embodiment, the LEDs used may emit standard white light or alternatively, the LEDs utilized may emit ultraviolet light, for use with modern drivers' licenses or other documentation equipped with UV-reflective holograms. Such an embodiment would be useful when checking the authenticity of a license.

In an embodiment, the surface of base 404 is covered in a non-slip material, such as a rubberized coating preventing document 416 from inadvertently moving from its position. The base 404 is further contemplated as being of a waterproof or bulletproof construction.

Second light source 414 is further provided similar to the embodiments above, providing a secondary light source, user 101 may direct as desired. In an embodiment, second light source 414 is removable from the base 404, and may be used as a separate, yet smaller light source, such as a flashlight.

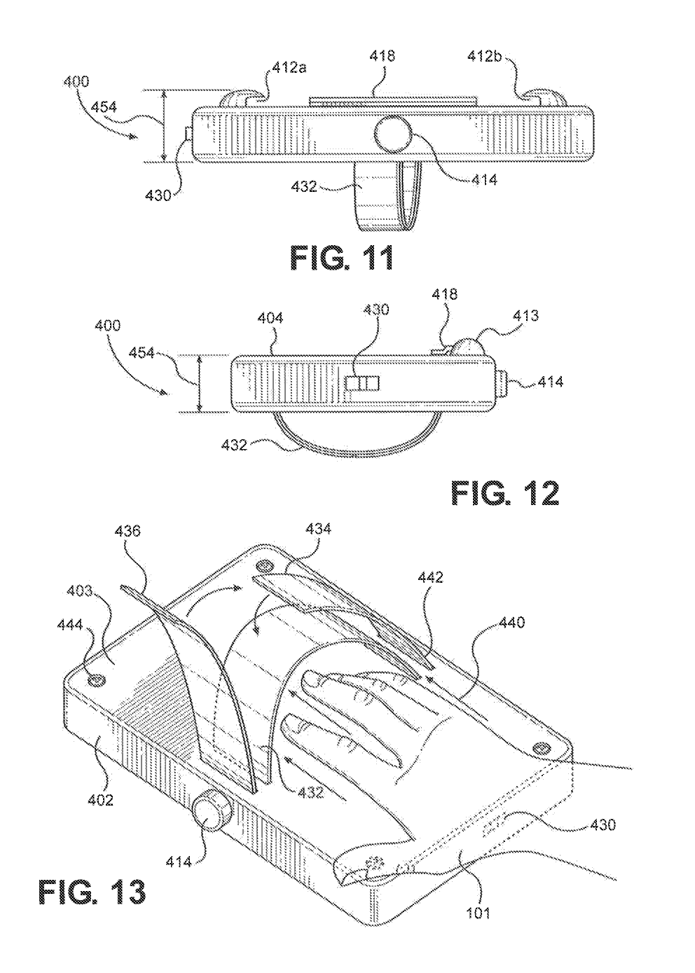

In use, the user 101 slides his or her hand along the back of hand-held device 404 through the adjustable hand-strap 432 (shown in FIG. 11 through FIG. 13), keeping the hand-held device 400 securely in place. The strap may be used for either left-handed or right-handed users 101.

Sufficient power switches 430 are further provided to give user 101 the ability to control which lights are activated, what program they will follow (steady, strobe), and on which power setting (high, medium, low, off).

FIG. 9 shows an alternative embodiment of hand-held device 400, with a second document 417 in upper clip 422 of two-sided fastener 418. Upper clip 422 operates the same as lower clip 420 by holding in place a second document 417, such as an ID card, while user 101 is also able to record information on document 416 which might likewise be an FI card. Light sources 412a and 412b remain, providing an adjustable source of light so the user 101 may view both documents with the provided illumination.

FIG. 10 shows the size of base 404 is dimension 450 by dimension 452, where these exemplary dimensions correspond to a size that is slightly larger than an index card, shown as document 416. For example, dimensions 450 and 452 could be sized to four inches and six inches, respectively, enabling easy use with a document 416 the size of a three by five inch or four by six inch index card. It is to be appreciated by those skilled in the art that many customizable dimensions are possible without departing from the spirit of the invention.

As described above, when securing a single document to lower clip 420, the user 101 may rotate shrouds 413 in the range 419, to maximize the light provided. The same may be done when two separate documents 417 and 417 are each secured in two-sided fastener 418. The shrouds 413 are equally adjustable, and in an embodiment, they may formed such that they are interchangeable as parts.

FIGS. 11 and 12 depict the adjustable hand strap 432, in addition to exemplary dimension 454. Dimension 454 in these figures is notionally approximately one inch, but can be narrower or wider as required. The purpose of dimension 454 is to provide sufficient internal space within the interior of hand-held device 400 for electronics and power supply, and sufficient space for a user's 101 hand, while keeping the intended compact nature of hand-held device 400 in mind,

Referring now to FIG. 13, the rear of hand-held device 400 is shown, with user 101 sliding his or her hand in direction 440 through adjustable hand strap 432. In an embodiment, adjustable hand strap 432 is formed from a strap with hook-and-loop fasteners, such as Velcro, formed into it. As shown, hook end 434 is adjusted and connected to loop end 436, allowing user 101 to adjust the position of hand-held device 400 for comfort or for different sized hands. It is to be appreciated by those skilled in the art that the adjustable hand strap 432 may be formed from other materials such as an elastic material or other similar fasteners known in the art.

The reverse side 403 of hand-held device 400 is formed with slots 442 through which adjustable strap 432 is moved, allowing adjustment, removal, or replacement of the entire strap. Access to the interior of the hand-held device 400 is provided through the removal of hardware 444, shown as four screws in this Figure. In an embodiment, the power supply, such as a battery or batteries 350 in FIG. 6, is housed within on the interior of the device 400. While this is not as convenient for battery 350 replacement, the security of the hardware 444 provides increased waterproofing and structural strength. An embodiment of the hand-held device 400 can however, have an externally accessible battery compartment (not shown) similar to FIG. 6.

We claim:

1. A hand-held device with a multi mode light source and a secondary illumination source comprising:
a base having a top, a bottom, and at least one fastening means for securing documents;
a first light source for illumination of said documents; and
a second light source for illumination of an adjacent subject.

2. The hand-held device with a multi-mode light source and a secondary illumination source of claim 1 wherein the base further comprises:
a base section having a hinge and a latch disposed at opposite ends; and
an upper section having a first edge affixed to said hinge and a second edge, disposed opposite said first edge and formed to accept said latch;
wherein said base section is formed with an interior storage area that is covered by said upper section when said upper section is rotated about said hinge and secured by said latch.

3. The hand-held device with a multi-mode light source and a secondary illumination source of claim 1, wherein said first light source further comprises:
at least two recessed lights disposed at opposite sides of said top of said base; and
shrouds partially covering each of said at least two recessed lights;
wherein said at least two recessed lights are recessed in said base, and wherein said shrouds are rotatable within said base and formed to direct light to said document.

4. The hand-held device with a multi-mode light source and a secondary illumination source of claim 3, further comprising a two-sided fastening means for securing a first document to said base at the top edge of said first document, while simultaneously securing a second document to said base at the bottom of said second document, wherein said shrouds are adjustable to simultaneously illuminate both documents.

5. The hand-held device with a multi-mode light source and a secondary illumination source of claim 4 further comprising an adjustable strap detachably attached to said base, opposite said two-sided fastening means allowing insertion and securing of a user's hand.

6. The hand-held device with a multi-mode light source and a secondary illumination source of claim 1, wherein said second light source is adjustable to provide light in a direction away from said top of said base and not on the longitudinal axis of said base.

7. A hand-held device, comprising
a base having a top, a bottom, and at least one fastening means for securing documents;
a primary light source for illumination of said documents;
a shroud adjacent said primary light source to direct illumination from said light source toward said documents; and
a secondary light source for illumination of an adjacent subject.

8. The device of claim 7, further comprising.
said base formed with a base section having a hinge and a latch disposed at opposite ends; and
an upper section having a first edge affixed to said hinge and a second edge, disposed opposite said first edge and formed to accept said latch;
wherein said base section is formed with an interior storage area that is covered by said upper section when said upper section is rotated about said hinge and secured by said latch.

9. The device of claim 8, wherein said secondary light source further comprises a multi-mode light source.

10. The device of claim 7, wherein said primary light source further comprises:
at least two recessed lights disposed at opposite sides of said top of said base; and
a shroud for each of said recessed lights wherein said shrouds are rotatable within said base and formed to direct light to said document.
